(19) United States
(12) Patent Application Publication
(10) Pub. No.: US 2009/0049314 A1
(43) Pub. Date: Feb. 19, 2009

(54) Method and System for Dynamic Voltage and Frequency Scaling (DVFS)

(76) Inventors: Ali Taha, San Diego, CA (US); Sani Gosali, Irvine, CA (US); Zhijun Gong, Iselin, NJ (US); Nelson Sollenberger, Farmingdale, NJ (US); John Wright, Poway, CA (US)

Correspondence Address: MCANDREWS HELD & MALLOY, LTD, 500 WEST MADISON STREET, SUITE 3400, CHICAGO, IL, 60661, US

(21) Appl. No.: 12/190,029

(22) Filed: Aug. 12, 2008

Related U.S. Application Data
(60) Provisional application No. 60/955,548, filed on Aug. 13, 2007.
(60) Provisional application No. 60/976,522, filed on Oct. 1, 2007.
(60) Provisional application No. 61/023,306, filed on Jan. 24, 2008.
(60) Provisional application No. 61/073,827, filed on Jun. 19, 2008.

(51) Int. Cl. G06F 1/00

(52) U.S. Cl. 713/300

(57) ABSTRACT

Methods and systems for dynamic voltage and frequency scaling (DVFS) may include monitoring change in resource utilization of an electronic device. If the change is greater than a threshold amount, a frequency of at least one clock and/or voltage for at least one voltage island may be adjusted. The resource utilization may be measured as, for example, a number of instructions executed per second. The frequency and/or voltage adjustment may depend on one or more operating points that may correspond to a power management state. An interrupt received in a power management state may also indicate an operating point. If resource utilization has increased, the frequency/voltage may be increased. Similarly, in cases where resource utilization has decreased, the frequency/voltage may be decreased. Voltage to circuits using the clock may be increased prior to increasing the clock frequency, and the voltage may be decreased after decreasing the clock frequency.

### CROSS-REFERENCE TO RELATED APPLICATIONS/INCORPORATION BY REFERENCE

This patent application makes reference to, claims priority to and claims benefit from U.S. Provisional Application Ser. No. 60/955,548 filed on Aug. 13, 2007; U.S. Provisional Application Ser. No. 60/976,522 filed on Oct. 1, 2007; U.S. Provisional Application Ser. No. 61/023,306 filed on Jan. 24, 2008 and U.S. Provisional Application Ser. No. 61/073,827 filed on Jun. 19, 2008.

Each of the above stated applications is hereby incorporated herein by reference in its entirety.

### FEDERALLY SPONSORED RESEARCH OR DEVELOPMENT

[Not Applicable].

### MICROFICHE/COPYRIGHT REFERENCE

[Not Applicable].

### FIELD OF THE INVENTION

Certain embodiments of the invention relate to secure processing systems. More specifically, certain embodiments of the invention relate to a method and system for dynamic voltage and frequency scaling (DVFS).

### BACKGROUND OF THE INVENTION

Power consumption performance of cellular handsets has become a major competitive factor due to many power hungry features such as High Speed Download Packet Access (HSDPA) since it directly impacts the user experience. Users pay special attention to battery life time for different applications such as, for example, talk time, MP3 play back time, display time, and video playback time.

While battery technology may be designed to provide more power for longer periods of time from smaller form factor electronic devices, these electronic devices may also be designed to reduce power consumption. For example, many electronic devices go into “sleep mode” when it is powered on but not used for a certain period of time.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for dynamic voltage and frequency scaling (DVFS), substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary electronic device, which may be utilized in connection with an embodiment of the invention.

FIG. 1B is a diagram illustrating active versus idle current consumption of an exemplary module in an electronic device, in accordance with an embodiment of the invention.

FIG. 2 is a diagram illustrating energy management in a mobile platform, which may be utilized in connection with an embodiment of the invention.

FIG. 3A is a diagram illustrating exemplary dynamic energy management, in accordance with an embodiment of the invention

FIG. 3B is a diagram illustrating exemplary dynamic energy management, in accordance with an embodiment of the invention

FIG. 4 is a diagram illustrating exemplary dynamic energy management, in accordance with an embodiment of the invention.

FIG. 5 is an exemplary diagram illustrating variance in number of instructions with time, in accordance with an embodiment of the invention.

FIG. 6 is a flow diagram illustrating exemplary steps for dynamic voltage and frequency scaling, in accordance with an embodiment of the invention.

FIG. 7 is a block diagram that illustrates exemplary optimization of DVFS performance using interrupts, in accordance with an embodiment of the invention.

FIG. 8 is a diagram illustrating exemplary policies, in accordance with an embodiment of the invention.

FIG. 9 is a diagram illustrating a policy that maps an operating state to a class of operating points, in accordance with an embodiment of the invention.

### DETAILED DESCRIPTION OF THE INVENTION

Certain embodiments of the invention may be found in a method and system for dynamic voltage and frequency scaling (DVFS). Aspects of the invention may comprise monitoring resource utilization in an electronic device and determining a change in the resource utilization that is greater than a threshold amount. If the determined change is greater than the threshold amount, a frequency of at least one clock and/or voltage for at least one voltage island may be adjusted. The resource utilization may comprise, for example, a number of instructions executed by a processor within a particular time period. The adjusting of the clock frequency may depend on a state of power management at the time of monitoring the resource utilization. The clock frequency and/or voltage may also be adjusted, for example, when an interrupt is received while in a power management state.

An operating point associated with the interrupt may be determined, where the operating point may comprise, for example, a clock frequency for various circuits in an electronic device and/or supply voltage to be used by those circuits. The operating point associated with the interrupt may be determined, for example, from a look-up table. Based on this, either the operating point associated with the interrupt or an operating point determined by a dynamically scaling a voltage and/or a frequency may be selected for use. The selection process may comprise, for example, selecting an operating point that may indicate whether to utilize a higher clock frequency. The selection process may be used, for example, in instances where an interrupt may be a member of specified class of interrupts. In instances where the interrupt is not a member of a specified class of interrupts, the operating point may be determined by dynamically scaling the voltage and/or frequency. The dynamic scaling of the voltage and/or the frequency may also be enable or disabled. For example, the dynamic scaling of the voltage and/or the frequency may be turned off when entering a deep sleep mode. In instances when the electronic device awakens from the deep sleep mode, the dynamic scaling of the voltage and/or the frequency may be turned on.

The amount of frequency adjustment may depend on, for example, one or more operating points that may correspond to each state of power management states for the electronic device. In instances where there is an increase in resource utilization over time, the frequency of the at least one clock may be increased. A supply voltage for circuits that use the clock may be increased prior to the frequency of the clock being increased. Similarly, in cases where there is a decrease in resource utilization over time, the frequency of the clock may be decreased. A supply voltage for circuits that use the clock may be decreased after decreasing the frequency of the clock.

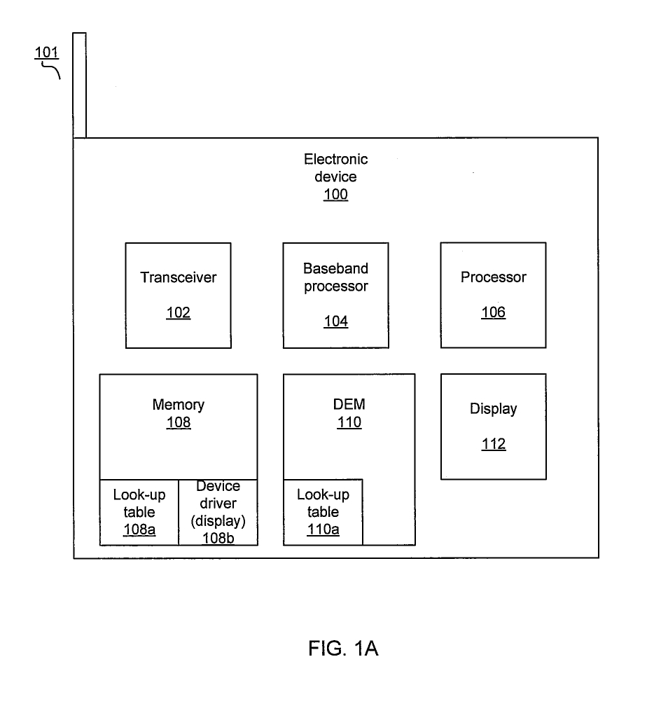

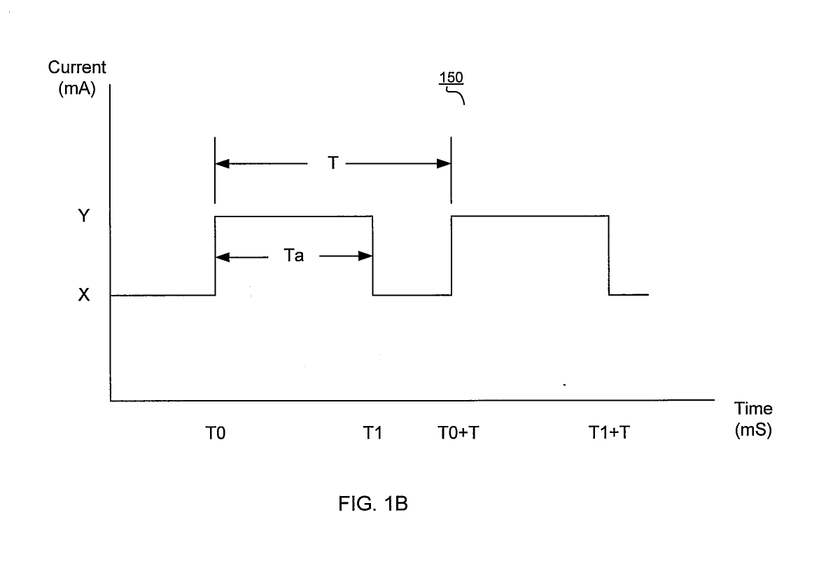

FIG. 1A is a block diagram of an exemplary wireless system, in accordance with an embodiment of the invention. Referring to FIG. 1A, the electronic device 100 may comprise an antenna 101, a transceiver 102, a baseband processor 104, a processor 106, a system memory 108, a dynamic energy management (DEM) module 110, and a display 112. The antenna 101 may be used for reception and/or transmission of RF signals, such as, for example, during a cellular call and/or receiving/transmitting multimedia files.

The transceiver 102 may comprise suitable logic, circuitry, and/or code that may be adapted to modulate and up-convert baseband signals to RF signals for transmission by one or more antennas, which may be represented generically by the antenna 101. The transceiver 102 may also be operable to down-convert and demodulate received RF signals to baseband signals. The RF signals may be received by one or more antennas, which may be represented generically by the antenna 101. Different electronic devices may use different antennas for transmission and reception. The transceiver 102 may be adapted to execute other functions, for example, filtering the baseband and/or RF signals, and/or amplifying the baseband and/or RF signals.

The baseband processor 104 may comprise suitable logic, circuitry, and/or code that may be operable to process baseband signals for transmission via the transceiver 102 and/or the baseband signals received from the transceiver 102. The processor 106 may be any suitable processor or controller such as a CPU or DSP, or any type of integrated circuit processor. The processor 106 may comprise suitable logic, circuitry, and/or code that may be adapted to control the operations of the transceiver 102 and/or the baseband processor 104. For example, the processor 106 may be utilized to update and/or modify programmable parameters and/or values in a plurality of components, devices, and/or processing elements in the transceiver 102 and/or the baseband processor 104.

Control and/or data information, which may comprise the programmable parameters, may be transferred from other portions of the electronic device 100, which may not be shown, to the processor 106. Similarly, the processor 106 may be operable to transfer control and/or data information, which may comprise the programmable parameters, to other portions of the electronic device 100, which are not shown, but which may also be part of the electronic device 100.

The processor 106 may utilize the received control and/or data information, which may comprise the programmable parameters, to determine an operating mode of the transceiver 102. For example, the processor 106 may be utilized to select a specific frequency for a local oscillator, a specific gain for a variable gain amplifier, configure the local oscillator and/or configure the variable gain amplifier for operation in accordance with various embodiments of the invention. Moreover, the specific frequency selected and/or parameters needed to calculate the specific frequency, and/or the specific gain value and/or the parameters, which may be utilized to calculate the specific gain, may be stored in the system memory 108 via the processor 106, for example. The processor 106 may also determine, for example, power control settings for the electronic device 100. The information stored in system memory 108 may be transferred to the transceiver 102 from the system memory 108 via the processor 106.

The system memory 108 may comprise suitable logic, circuitry, and/or code that may be operable to store a plurality of control and/or data information, comprising parameters needed to calculate frequencies and/or gain, and/or the frequency value and/or gain value. The system memory 108 may also be enabled to store, for example, one or more look-up tables 108a and/or device drivers 108b that may be used by an embodiment of the invention. For example, a look-up table 108a in the system memory 108 may be used for power control by the DEM module 110. The device driver 108b, which may comprise a display driver, may be used to control display of video and images. For example, the device driver 108b, which may comprise a display driver, may control refreshing of the display 112, which may be, for example, an LCD display.

The DEM module 110 may comprise suitable logic, circuitry, and/or code that may enable controlling of power consumption by the electronic device 100. For example, the DEM module 110 may comprise one or more circuits that may be used to control, for example, clock frequencies and/or voltage levels for one or more portions of the electronic device 100. An area of a chip may be supplied a common voltage, and this area may be referred to as a voltage island. The DEM module 110 may also comprise code that may be executed by, for example, the processor 106 in setting a clock frequency and/or voltage levels for circuits in the electronic device 100. The DEM module 110 may also comprise one or more look-up tables 110a that may be used by an embodiment of the invention. For example, the look-up table 110a may be used for power control by the DEM module 110.

The display 112 may comprise suitable circuitry and/or logic that may be operable to display video and/or images. For example, the display 112 may be used to display menus, videos, digital photographs, and/or background images.

While the electronic device 100 may have been described as comprising a wireless interface, the invention need not be so limited. Various embodiments of the invention may be used for wired devices, and/or mobile electronic devices that do not transmit and/or receive wireless signals. Generally, various embodiments of the invention may be used for any electronic device.

FIG. 1B is a diagram illustrating active versus idle current consumption of an exemplary module in an electronic device, in accordance with an embodiment of the invention. Referring to FIG. 1B, there is shown a graph 150. The graph 150 may illustrate total current consumption by a hardware circuit, where the total current consumption is due to two sources of current consumption—active current consumption and idle current consumption.

Active current consumption may be a sum of a clock current plus the active data path processing current while a task is being performed. Idle current consumption may be a clock current consumption while no data is being processed.

In the graph 150, a clock, for example, a system clock for the processor 106, may have been running without performing any tasks before time instance T₀. For ease of explanation, it may be assumed that a task takes place regularly every T seconds. A processor may be assumed to be active for a period of Tₐ and idle for a period of T-Tₐ. Accordingly, active data processing may start at time T₀ and current consumption may increase from X mA to Y mA. When the task is finished at time T₁, the current consumption may drop down to X mA again. Given the assumption that such a task is performed periodically every T ms, the idle, active, and total current consumption penalty may be calculated as:

C_{idle}(mAmS)=X(T−Tₐ) (1)

C_{active}(mAmS)=Y Tₐ (2)

C_{Total}(mAmS)=C_{idle}+C_{active} (3)

The total current consumption in Amperes over a period of time in seconds may be expressed as a battery charge in Coulombs. The unit mAms may be the amount of current expressed as milli-amperes (mA) over a period of time in milli-seconds (mS), and accordingly, may be expressed as micro-Coulombs.

The current consumption penalty with the units of mAms may be the equivalent battery charge needed to perform a task. For example, a cell phone battery may have a charge capacity of 800 mAh or 2880 Coulombs:

$$\begin{matrix}800 mA h = ( 800 * {10}^{- 3} ) A * ( 1 hour ) * ( 3600 seconds \text{/} hour ) \\ = 2880 C\end{matrix} \qquad ( 4 )$$

The average current consumed may be calculated as:

$${I}_{ave} = \frac{{YT}_{a} + X ( T - {T}_{a} )}{T} \\ where \\ \frac{{T}_{a}}{T} \qquad ( 5 )$$

may be the active utilization percentage or duty cycle while

$$( 1 - \frac{{T}_{a}}{T} )$$

may be the idle percentage.

The current consumption of various circuit modules in an electronic system may be modeled as:

I=[Active Utilization Percentage×Active mA/MHz+(1−Active Utilization Percentage)×Idle mA/MHz]×Clock frequency (6)

where Active and Idle mA/MHz may be normalized current consumption coefficients for that particular model per MHz of clock frequency. This may be true due to the fact that current consumption may tend to increase linearly with frequency.

Since Active Utilization Percentage may be replaced by a unit of instructions processed (million instructions per second, or MIPS) divided by the clock frequency, it may be shown that the current consumption may also be modeled as:

I=MIPS×Active mA/MHz+(Clock Frequency−MIPS)×Idle mA/MHz (7)

where MIPS may be the required number of instructions for conducting the task.

To develop power consumption models for various modules and processors, such as, for example, processors using the advanced RISC machine (ARM) architecture, digital signal processors (DSPs), which may communicate, for example, using the advanced high-performance bus (AHB), the active utilization percentage of each module, including the AHB, and the associated clock frequencies may need to be known. This may be accomplished by monitoring, for example, the ARM processor, DSP, and/or AHB activity while a particular task is being run. The Idle mA/MHz coefficients of a particular module may be calculated by running the same application at two different clock frequencies for that particular module while everything else is the same, and then measuring the current for each case:

I1=MIPS×Active mA/MHz+(Clock Frequency 1−MIPS)×Idle mA/MHz (8)

I2=MIPS×Active mA/MHz+(Clock Frequency 2−MIPS)×Idle mA/MHz (9)

I2−I1=(Clock Frequency 2−Clock Frequency 1)×Idle mA/MHz (10)

Accordingly,

Idle mA/MHz=(I2−I1)/(Clock Frequency 2−Clock Frequency 1) (11)

Active mA/MHz may now be calculate from either I1 or I2:

Active mA/MHz=[I1−(Clock Frequency 1−MIPS)×Idle mA/MHz]/MIPS (12)

Separate power consumption characterization may be utilized for a specific type of processor, such as, for example, ARMs and/or DSPs, and other modules in an electronic device.

Given that power consumption per unit time may be characterized for various modules, it may be necessary to determine the amount of time that a task may require to determine total power consumption per task. If a task requires N MIPS in order to be processed, then the clock frequency of a processor, such as, for example, the processor 106, may need to be at least at N MHz where code is assumed to be executed at a rate of N instructions per second. This may be explained utilizing various exemplary scenarios.

In a first scenario, if a processor runs at a rate of M MHz, where M>>N, then the task may be quickly performed within the first N MHz cycles of the clock. This may be equivalent to a utilization percentage of

$$\frac{N}{M} .$$

Therefore, the current consumption equation may be written as:

I=A N+B(M−N) (13)

where A may be the active mA/MHz and B may be the idle mA/MHz coefficients.

In another scenario, if the processor 106 runs at a rate of P MHz, where P is close to N and slightly bigger than N, then the utilization percentage N/P may be close to 1 and the current consumption equation may be written as:

I=A N+B(P−N) (14)

Since N may be close to P, the current may be approximated as:

I=A N (15)

Since current consumption by circuits in a chip generally tends to correlate linearly with clock frequency, the active current consumption may be the same for both scenarios. However, the current consumption for the scenario described by Equation (13) may be higher by an amount of B*(M—P). This may be due to the idle clock current consumption after a task may already have been processed.

Consider an example where a module may use a 104 MHz clock versus 52 MHz clock for a task that requires only 30 MIPS, with B=0.2 mA/MHz. In this case, running the module at the unnecessarily higher frequency of 104 MHz would result in consuming an extra 10.4 mA of current for the period of time after a task has been completed:

$$\begin{matrix}I = B * ( M - P ) \\ = ( 0.2 mA \text{/} MHz ) * ( 104 MHz - 52 MHz ) \\ = ( 0.2 ) ( 52 ) mA \\ = 10.4 mA .\end{matrix} \qquad ( 16 )$$

An embodiment of the invention may enable some, but not all, of the clocks to be scalable through DVFS algorithm. Hence, there may be some clocks that may run at constant frequencies regardless of DVFS mechanism. DVFS may take into account the power consumption implications of such constant non-scalable overhead when choosing an operating vector (frequencies and voltage) for the scalable clocks. Scaling down the frequencies may reduce idle power consumptions of scalable clocks. However, some of this power savings gain may be affected by increased penalty of the non-scalable constant overhead due to lengthening the time for executing a particular task. This may mean that the optimal operating vector might not necessarily correspond to the lowest operating vector in terms of clock frequencies and voltage. This may be mathematically modeled as follows:

I=A N+B(M−N)+K (17)

where K may correspond to the constant non-scalable overhead current. In the presence of such non-scalable overhead, DVFS may try to minimize I multiplied by the time required to execute the task. Accordingly, DVFS may choose the frequency N in a way that I×T is minimized where T is the time required to execute the task at frequency N. So, the optimal operating frequency may be chosen as:

Min(A N T+B(M−N)T+K T) (18)

where the minimization operator is taken over N. In general, T may be inversely proportional to N. That is, as N increases, T decreases, and vice versa.

In addition to controlling the clock frequency, voltage may also be controlled for a module. For example, a module may be able to operate at lower voltages for certain ranges of clock speeds. This may also reduce power consumption by an electronic device, since power is defined as voltage times current. Accordingly, various embodiments of the invention may comprise power vectors, or operating points, where each power vector may comprise a clock frequency and a voltage level. Each operating point may apply, for example, to a specific processor and/or hardware architecture. Accordingly, an operating point that may be used to support three hardware architectures may comprise a clock frequency and voltage level for each of the hardware architectures. The voltage level may be ignored if, for example, a platform only supports one voltage level.

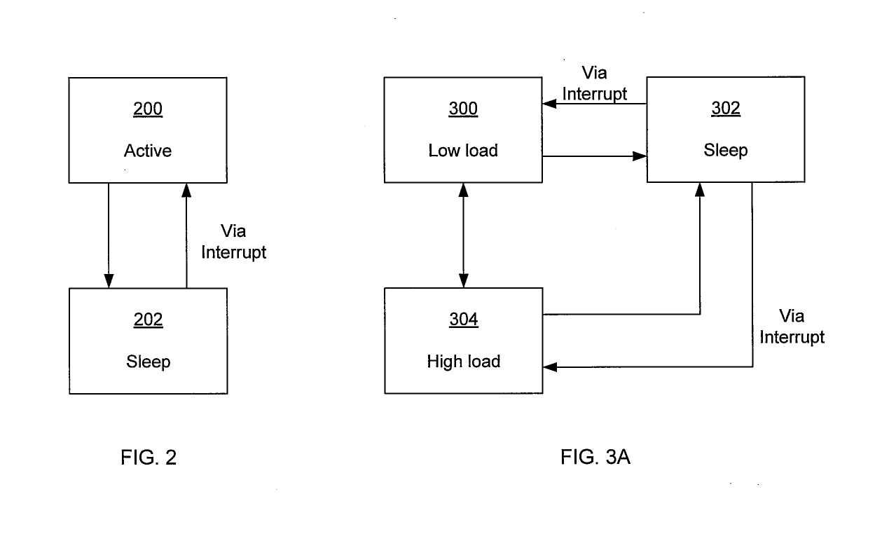

FIG. 2 is a diagram illustrating energy management in a mobile platform, which may be utilized in connection with an embodiment of the invention. Referring to FIG. 2, there are shown states 200 and 202 for a simple energy management algorithm. State 200 may indicate that an electronic device, such as, for example, the electronic device 100, may be in an active state. The active state 200 may be a state where a module may be using a pre-determined clock speed and voltage level. For this exemplary simple case, there may be a single operating point for each hardware/processor architecture in the active state 200. For example, if three processors are supported, the operating point may comprise a clock frequency and a voltage level for each of the three processors.

Based on various criteria, which may be design dependent, the electronic device may transition to deep sleep state 202 from the active state 200. For example, if the electronic device 100 has not received any user input for a period of time and if the electronic device 100 has not received an incoming call or data for a period of time, the electronic device 100 may transition to the deep sleep state 202. In the deep sleep state 202, the electronic device 100 may reduce clock speed to a module, and/or reduce voltage to the module.

The electronic device 100 may transition from the deep sleep state 202 to the active state 200 upon one or more trigger conditions, which may be design dependent. For example, any incoming call, or a key push by the user may be a trigger condition that may provide transition from the sleep state 202 to the active state 200. The transition from the deep sleep state 202 to the active state 200 may be via an interrupt, for example.

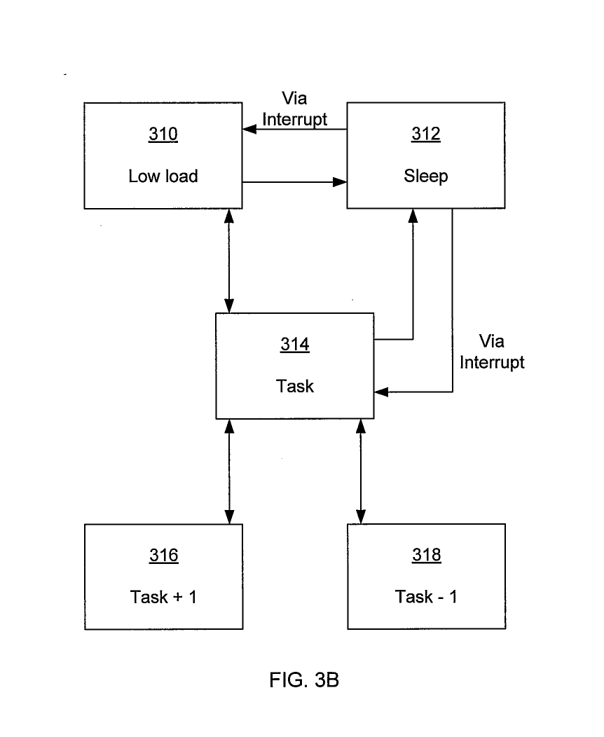

FIG. 3A is a diagram illustrating exemplary dynamic energy management, in accordance with an embodiment of the invention. Referring to FIG. 3A, there are shown states 300, 302, and 304. State 300 may be a state that may indicate a low load state. State 302 may be a deep sleep state that may be similar to the deep sleep state 202 described with respect to FIG. 2. State 304 may be a high load state where a task is running that may require a higher clock speed than in state 300 or 302. The electronic device 100 may power up in state 304 as a default, for example. However, various embodiments of the invention may allow, for example, the state 300 to be a default state.

Accordingly, there may be a transition from the state 300 or the state 302 to the state 304 based on one or more trigger conditions. The specific trigger conditions for transitioning from the state 300 or the state 302 to the state 304 may be design dependent. The deep sleep state 302 may not have multiple operating points associated with it since the electronic device 100 may set the clock speed for each module affected to, for example, a lowest clock speed that may be available. The voltage may also be lowered, for example, in the deep sleep state 302.

The low load state 300 and the high load state 304 may be associated with a plurality of operating points that may indicate a clock speed and/or voltage level for operation. An embodiment of the invention may enable the low load state 300 and the high load state 304 to use the operating points based on, for example, tasks that may be running. For example, the low load state 300 may comprise a period of time when the tasks running in the electronic device do not require as many resources as during the high load state 304. For example, when a high demand task is nearing the end in the high load state 304, and tapering off in its resources requirement, the electronic device 100 may transition to the low load state 300. When there are no further demands in the low load state 300, the electronic device may transition to the deep sleep state 302. Various embodiments of the invention may allow a transition directly from the high load state 304 to the deep sleep state 302 when a task finishes.

In an exemplary scenario, the electronic device 100 may be in the deep sleep state 302 when a user presses a key to make an outgoing call. The electronic device may then transition to the low load state 300 to process the key presses and call connection. While in the low load state 300, the electronic device 100 may be enabled to download and process video. Accordingly, the electronic device 100 may transition to the high load state 304. When the video processing finishes, and there is no call in progress, the electronic device 100 may transition from the high load state 304 to the deep sleep state 302. Similarly, when the video processing finishes, and there is a call still in progress, the electronic device 100 may transition from the high load state 304 to the low load state 300. The switching of operating points for using various clock frequencies and/or voltage levels may be design dependent. For example, dynamically scaling voltage and/or clock frequency may be used for switching of operating points. In one embodiment of the invention, the dynamically scaling voltage and/or clock frequency may be based on processor load-scaling (MIPS-based scaling) algorithm and/or any other method or technique. Updates and/or enhancements may be made to the manner in which the voltage and/or clock frequency may be scaled based on various characteristics of the electronic device 100.

Various embodiments of the invention may allow different levels of sleep mode in the low load state 300 and the deep sleep mode 302. For example, the electronic device 100 may enter a sleep mode while in the low load state 300. The electronic device 100 may then be awakened periodically via interrupts so that it may service various housekeeping tasks such as monitoring memory usage, for example. The periodic rate at which the electronic device 100 may be awakened from its sleep mode may be, for example, every 100 mS. The periodic rate may be adaptive and/or may vary depending on the application. The periodic rate may be adaptive and/or may vary depending on the application.

The electronic device 100 may also be awakened from the deep sleep state 302 by, for example, an interrupt that may indicate that a new task may be ready to execute. Once an interrupt is received, the electronic device 100 may be operable to determine whether the interrupt belongs to a specific class or classes of interrupts that require indication of pending task that may need increased resources. If the interrupt does belong to a specific class, then clock frequency may be increased to a new clock frequency regardless of what the current clock frequency may be, or what the dynamic scaling of the voltage and/or clock frequency technique may indicate that the new clock frequency should be.

The design of the state machine and determination of a state that the electronic device 100 is in when it is awakened from either the sleep mode in the low load state 300 or the deep sleep mode in the deep sleep state 302 may be design dependent. However, an embodiment of the invention may use a software global variable or a hardware register to indicate the state that it may be in. Other embodiments of the invention may, for example, determine the time from the most recent interrupt to the previous interrupt. If the determined time is not approximately equal to the periodic wake-up time for the sleep mode in the low load state 300, then the electronic device 100 may determine that it may be in the deep sleep state 302.

Furthermore, various embodiments of the invention may allow turning off the dynamic scaling of the voltage and/or clock frequency when the electronic device 100 is in deep sleep state 302 since, for example, the deep sleep state 302 may be associated with just one operating point where the clock frequency and/or supply voltages may be at the lowest level allowed. When the electronic device 100 transitions out of the deep sleep state 302 to another state, the dynamic scaling of the voltage and/or clock frequency may be turned on.

While an embodiment of the invention may have been described with three states, the invention need not be so limited. For example, various embodiments of the invention may comprise any number of states comprising a sleep state and a plurality of task states. Accordingly, the granularity of power usage may be better controlled according to design criteria.

Various embodiments of the invention may provide a framework that may support using a DVSF algorithm in the electronic device 100. The framework may be referred to, for example, as a dynamic energy management (DEM) architecture. The DEM module 110 may be an implementation of the DEM architecture, and may be designed to not depend on specific operating systems, nor to specific applications. Accordingly, the DEM module 110 may provide functionality that may prevent switching to invalid operating points during the run-time. For example, when a liquid crystal display (LCD), which may be the display 112, on the electronic device 100 is refreshing, the DEM module 110 should not switch to a low load state where the clock speed may be below that required for refreshing the LCD 112. This may be accomplished, for example, by the display driver 108b asserting a constraint to the DEM module 110 to prevent transitioning to the low load state 300. When the LCD refresh is finished, the display driver 108b may remove the constraint.

FIG. 3B is a diagram illustrating exemplary dynamic energy management, in accordance with an embodiment of the invention. Referring to FIG. 3B, there are shown states 310, 312, 314, 316, and 318. State 310 may be a state that may indicate a low load state, and may be similar to state 300. State 312 may be a sleep state that may be similar to the sleep state 202 described with respect to FIG. 2. States 314, 316, and 318 may be a high load states where a task may be running that may require a higher clock speed than in state 310 or 312. The electronic device 100 may power up, for example, in state 314 as a default.

Accordingly, the transition from the states 310, 312, and 314 may be similar to the transitions from the states 300, 302, and 304. The states 314, 316, and 318 may provide finer granularity regarding the amount of power that may be consumed in each of the states. That is, the tasks running on the electronic device 100, as well as the states of the tasks, may be tracked more closely to provide a better control over clock frequencies and/or voltage levels. This may allow better control over power consumed at various points in the operation of the electronic device 100.

Accordingly, there may be a transition from the states 314, 316, and 318 based on one or more trigger conditions. The specific trigger conditions for transitioning from the state 314, 316, and 318 may be design dependent. The transitions from the states 314, 316, and 318 to the other states 310 and 312 may also be design dependent. Various embodiments of the invention may allow transitions from any one state to any other state. Other embodiments of the invention may restrict transitions between states. For example, a restriction may only allow transition to the state 312 from the state 310, and a transition to the state 310 only from state 314. The states 310, 314, 316, and 318 may be associated with a plurality of sets of operating points that may indicate a clock speed and/or voltage level for operation.

The transition among at least the states 314, 316, and 318 may also be influenced by information from higher layers, such as, for example, applications, and/or operating systems. Accordingly, an application may indicate that the electronic device 100 may need to be in state 316, for example, rather than state 314. Similarly, an application may indicate that the electronic device 100 should be in state 318 rather than state 314.

In an exemplary embodiment of the invention, the electronic device 100 may be in the sleep state 312 when a user activated a key or function to make an outgoing call. The electronic device may then transition to the low load state 310 to process the key presses and call connection. While in the low load state 310, the electronic device 100 may be enabled to download and process video. Accordingly, the electronic device 100 may transition to the high load state 314. During the processing of the video, some sections may require more processing resources than others. During these periods, there may be a transition from the high load state 314 to a higher load state 316. At other times, the video processing may require fewer resources than needed in the high load state 314 or the higher load status 316. Accordingly, the electronic device 100 may transition to state 318, which may allocate a clock frequency and/or voltage that may be less than allowed by the states 314 or 316, and yet greater than that allowed by the state 310.

Similarly as described with respect to FIG. 3A, various embodiments of the invention may allow different level of sleep modes in the low load state 310 and the deep sleep mode 312. For example, the electronic device 100 may enter a sleep mode while in the low load state 310. The electronic device 100 may then be awakened periodically via interrupts so that it may service various housekeeping tasks such as monitoring memory usage, and/or network activity, for example. The periodic rate at which the electronic device 100 may be awakened from its sleep mode may be, for example, every 100 mS.

The electronic device 100 may not be awakened from the deep sleep state 312 periodically, but by, for example, an interrupt that may indicate that a new task may be ready to run. The electronic device may be operable to determine whether the interrupt belongs to a specific class or classes of interrupts that require indication of pending task that may need increased resources. If the interrupt does belong to a specific class, then clock frequency may be increased to a new clock frequency regardless of what the current clock frequency may be, or what the dynamic scaling of the voltage and/or clock frequency may indicate that the new clock frequency should be.

The design of the state machine and determination of a state that the electronic device 100 is in when it is awakened from either the sleep mode in the low load state 310 or the deep sleep mode in the deep sleep state 312 may be design dependent. However, an embodiment of the invention may use a software global variable or a hardware register to indicate the state that it may be in. Other embodiments of the invention may, for example, determine the time from the most recent interrupt to the previous interrupt. If the determined time is not approximately equal to the periodic wake-up time for the sleep mode in the low load state 310, then the electronic device 100 may determine that it is in the deep sleep state 312.

Furthermore, various embodiments of the invention may allow turning off the dynamic scaling of the voltage and/or clock frequency when the electronic device 100 is in deep sleep state 312 since, for example, the deep sleep state 312 may be associated with just one operating point where the clock frequency and/or supply voltages may be at the lowest level allowed. When the electronic device 100 transitions out of the deep sleep state 312 to another state, the dynamic scaling of the voltage and/or clock frequency may be turned on.

While an embodiment of the invention may have been described with a plurality of states, the invention need not be so limited. For example, various embodiments of the invention may comprise more states than described with respect to FIG. 3B.

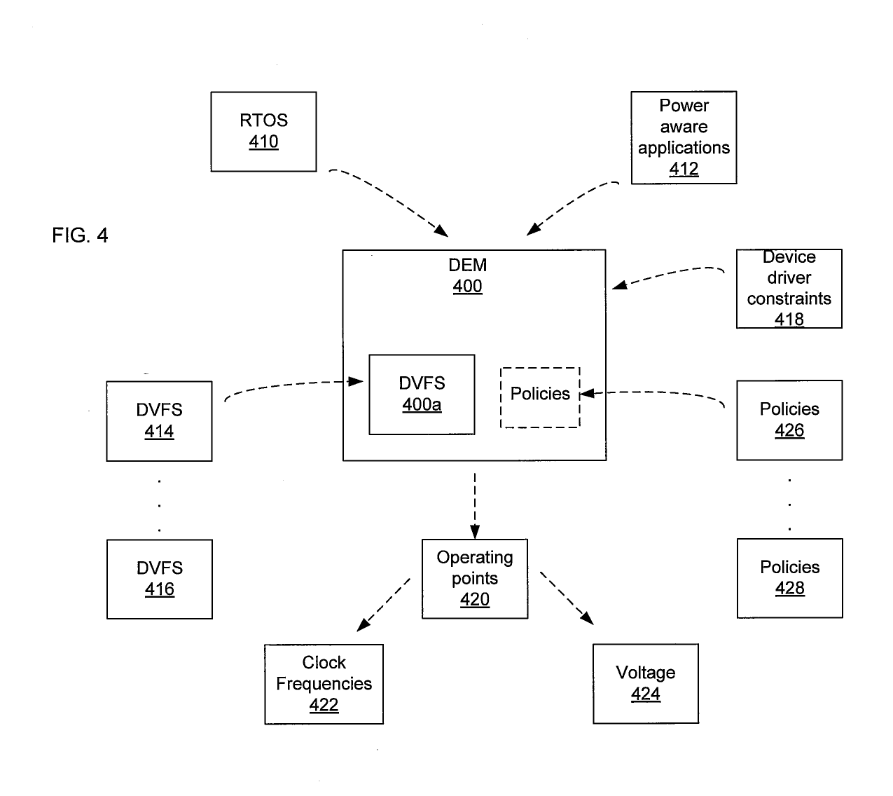

FIG. 4 is a diagram illustrating exemplary dynamic energy management architecture, in accordance with an embodiment of the invention. Referring to FIG. 4, there is shown a DEM module 400, which may be similar to the DEM module 110. There are also shown a plurality of modules 410-428 that the DEM module 400 may interface with. More specifically, there is shown real-time operating system (RTOS) 410, power aware applications 412, DVFS processing module 414 . . . 416, constraints 418, operating points 420, clock frequencies 422, core voltages 424, and policies 426 . . . 428.

The real-time operating system (RTOS) 410 and power-aware applications 412 may comprise suitable logic and/or code that may be operable to indicate task state changes to the DEM 400. Accordingly, the DEM module 400 may change power control states based on input from the RTOS 410 and/or the power-aware applications 412. The DVFS processing module 400a may then select an appropriate power vector, or an operating point, for use in the electronic device 100. The RTOS 410 may also provide information regarding real time processor utilization.

One of the DVFS processing modules 414 . . . 416 may be selected to be used by the DEM module 400 for the DVFS processing module 400a in the electronic device 100. The DVFS technique selected may be, for example, the most recent DVFS technique downloaded to the electronic device 100 and/or a technique that may be the most appropriate for the applications that may be loaded on the electronic device 100. The DVFS technique selected may determine the operating point to use depending on the state of the electronic device 100.

The DEM module 400 may also provide access to constraints 418 that may be used by various device drivers 108b and or tasks to provide a lower limit for clock frequency and/or voltage when a specific device and/or task is running. The constraints may be, for example, function calls.

The DEM module 400 may generate the operating points 420 that may indicate, for example, clock frequencies 422 and/or the core voltages 424. The operating points 420 may be based on, for example, the policies 426 . . . 428 that may be loaded on to the electronic device 100. The policies 426 . . . 428 may comprise, for example, data that may be specific for different hardware, such as, for example, chip sets for a specific hardware architecture. Accordingly, the operating points may depend on the hardware architecture/processor used as well as chip set used for the hardware architecture/processor.

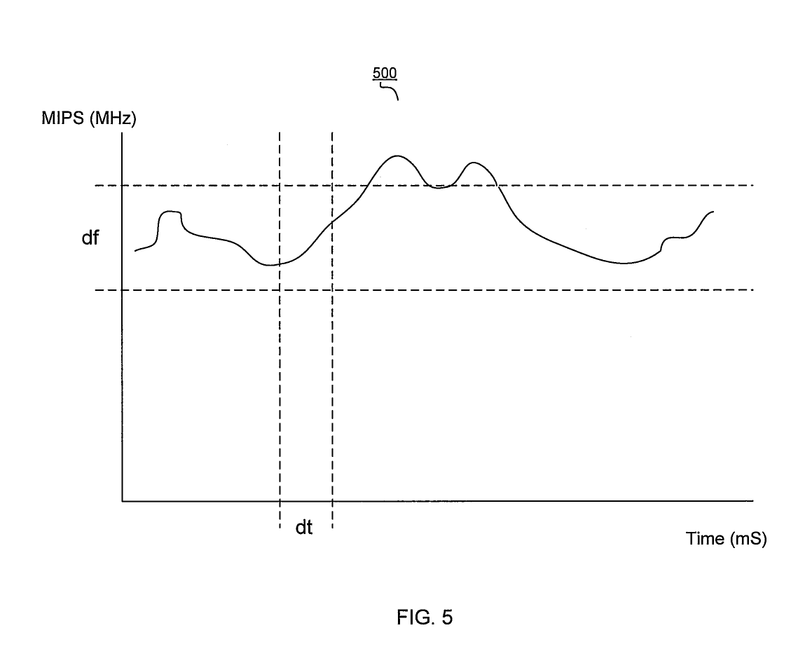

FIG. 5 is an exemplary diagram illustrating variance in number of instructions with time, in accordance with an embodiment of the invention. Referring to FIG. 5, there is shown a graph 500 that may illustrate the number of instructions executed over a period of time. In an embodiment of the invention, the DVFS processing module 400a may periodically monitor a load scale by assessing the MIPS profiling information for one or more processors to accommodate the system load. Periodic profiling information, which may comprise information similar to data shown on the graph in FIG. 5, may be accessed by, for example, the DEM 400. The period for monitoring may be design dependent. An algorithm for determining the monitoring period may also allow dynamically changing the monitoring period if, for example, processor usage varies greatly from one monitored value to another. Also, an operating system and/or resource consumption aware applications may also request that the power control state be set to a specific state. Generally, though, an algorithm for determining resource usage may average usage over a time window to lessen the effects of spurious processor usage. The averaging may be design and/or application dependent. Notwithstanding, the processor usage may be used to adjust a clock frequency and/or supply voltage, and this adjustment may be referred to as load scaling.

Various embodiments of the invention may allow a rate of monitoring the system load to be fast enough to enable switching of the clock frequencies to higher rates in cases of demanding applications requiring higher processing power. The DVFS processing module 400a may also be conservative in selecting operating clock frequencies so that in case load scaling increases immediately after operating clock frequencies are set, the electronic device 100 may still be able to accommodate the new system load until the operating clock frequencies may be adjusted at the next available time. Hence, a tolerance margin may be added to the required number of MIPS where the margin may be design dependent. An exemplary tolerance margin may be 10%.

The DVFS processing module 400a may periodically monitor utilization for each of the processors that may be on the electronic device 100. A margin may be added to each MIPS number for the processor, and a lowest operating point may be selected that may accommodate the processor load. The operating point may be selected from, for example, a database such as a look-up table. For each set of operating clock frequencies, the appropriate supply voltage levels may have been tabulated so that such supply voltage values may be adjusted appropriately, if voltage scaling is available. Some power management units (PMUs) may support supply voltage scaling via, for example, I²C commands.

Voltage scaling may take into account various parameters, such as, for example, operating clock frequency vector to accommodate required MIPS for a particular application, or a scenario where a plurality of applications may be running simultaneously. Additionally, the voltage scaling may take into account the process that resulted in the chip. For example, the chip may be characterized as fast, typical, or slow, or some other speed designation. Voltage scaling may also take into account temperature of the chip as the temperature may affect operation of the chip. Accordingly, a baseline parameter may be generated for controlled temperatures and/or voltages. A baseline parameter may comprise, for example, counting oscillations of a ring oscillator at a controlled voltage and temperature. Then, as the voltage may be changed, or the temperature may vary, the oscillation reading for a given period may vary with respect to the baseline parameter. Accordingly, variations in the oscillation reading may be used for determining changes to voltage and/or clock frequency. The oscillation readings may be averaged, for example, and/or combined from ring oscillators that may be placed in various parts of a chip. A specific method, including temperature and voltage sensors, for determining effects of voltage and/or temperature may be design dependent.

In various embodiments of the invention, the PMU may be operable to adjust the supply voltages to the correct values. For example, if a clock frequency is to be scaled down, the supply voltage may be decreased after the clock is scaled. However, if the clock is to be scaled up, the supply voltages may need to be increased to appropriate levels before scaling up the clock frequencies. The operating vector margin, the periodicity of DVFS algorithm, and the time required for the supply voltages and clock frequencies to effectively adjust to their new values may be design dependent. MIPS margin may be added to the minimum required number of MIPS based on processor usage information in order to avoid overdriving the processors.

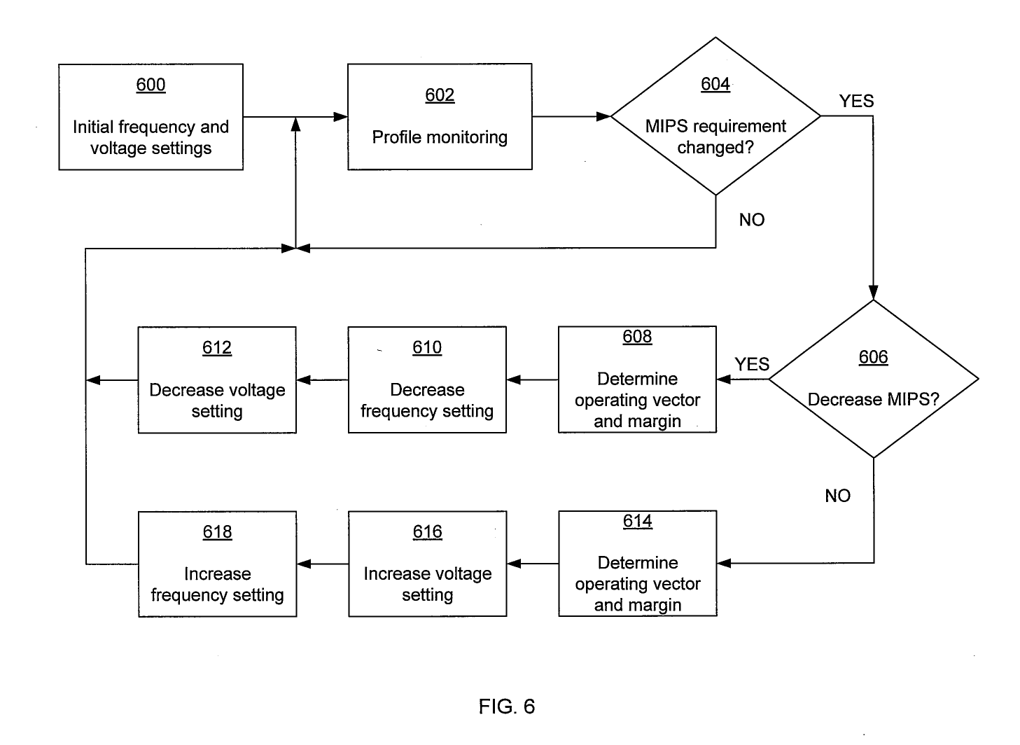

FIG. 6 is a flow diagram illustrating exemplary steps for dynamic voltage and frequency scaling, in accordance with an embodiment of the invention. Referring to FIG. 6, there are shown steps 600 to 618. In step 600, an initial clock frequency and voltage setting may be made to the electronic system 100. This may correspond to, for example, the low load state 300 or 310. In step 602, the electronic device 100 may perform periodic profile monitoring. For example, step 602 may monitor utilization of system resources, such as, for example, CPU usage, bus usage, the amount of MIPS for a task to be performed, or being performed. Step 602 may also determine, for example, the change in rate of resource usage in a plurality of past monitoring windows, where the number of monitoring windows used and the period of each monitoring window may be design and/or implementation dependent. The specific method for system resource monitoring may be design and/or implementation dependent.

In step 604, the electronic device 100 may use the profile monitor information to determine whether MIPS requirement may have changed. For example, an embodiment of the invention may use system resource usage and compare that to a usage threshold. Other embodiments of the invention may use the rate change for system usage for several monitoring windows to determine whether MIPS requirement may have changed. For example, an absolute value of change in rate of system usage that may be greater than a certain rate threshold may indicate that MIPS requirement may have changed. For example, an embodiment of the invention may monitor rate changes greater than 5% over four monitoring windows.

Still other embodiments of the invention may use a combination of absolute system resource usage and/or system usage rate change in determining whether MIPS requirement may have changed. For example, an embodiment of the invention may use an algorithm that may allow detecting change in the MIPS requirement if an absolute system resource usage, such as, for example, expected MIPS for a particular task, is greater than the usage threshold. That algorithm may also enable determining change in the MIPS requirement if a rate change is greater than the rate threshold, even if the absolute system resource usage is not greater than the usage threshold.

Still other embodiments of the invention may, for example, use the distance from the usage threshold value and the distance from the rate threshold value to determine whether MIPS requirement may have changed. Accordingly, various methods, which may be design and/or implementation dependent, may be used to determine whether MIPS requirement may have changed. While a single usage threshold and a single rate threshold may have been described for simplicity, the invention need not be so limited. For example, a plurality of usage thresholds and/or a plurality of rate threshold may be used. If it is determined that the MIPS requirement has changed, the next step may be step 606. Otherwise, the next step may be the monitoring step 602.

In step 606, the electronic device 100 may determine whether the MIPS requirement should be decreased. If so, the next step may be step 608. Otherwise, the next step may be step 614. In step 608, the electronic device 100 may determine the appropriate operating point, for example, via a look-up table, and may add an appropriate MIPS margin. In step 610 the clock frequency setting may be decreased appropriately. In step 612, the supply voltage may then be decreased appropriately. The next step may be step 602.

In step 614, the electronic device 100 may determine the appropriate operating point, for example, via a look-up table, and may add an appropriate MIPS margin. In step 616, the supply voltage may be increased to an appropriate level. In step 618, after waiting an appropriate time for the supply voltage to settle, the clock frequency setting may be increased appropriately. The next step may be the monitoring step 602.

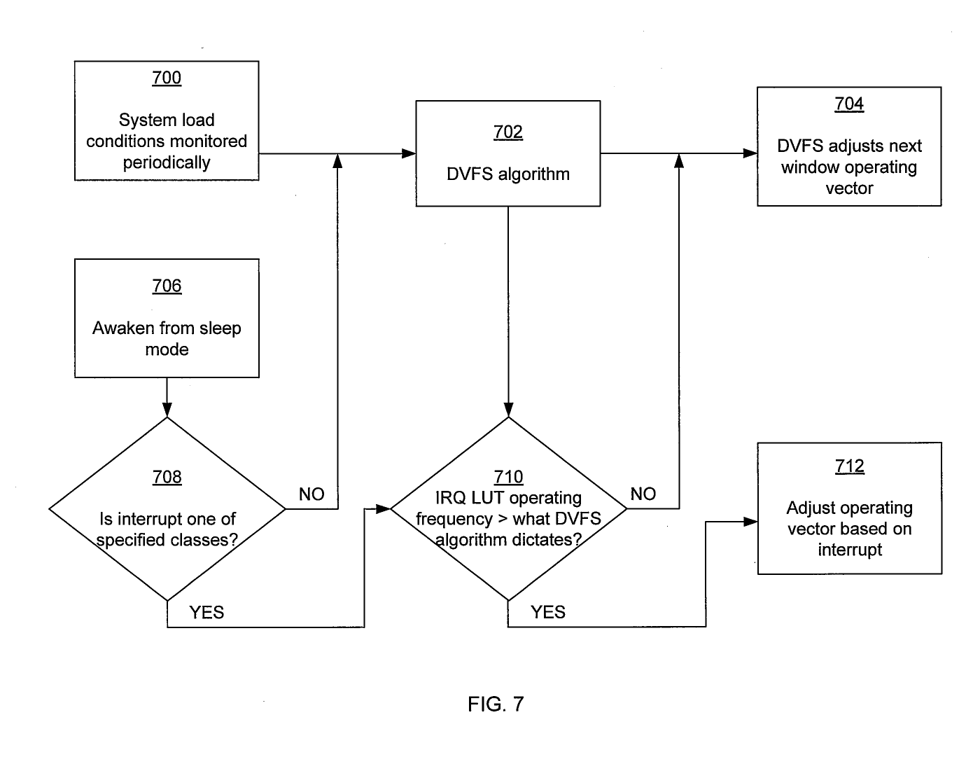

FIG. 7 is a block diagram that illustrates exemplary optimization of DVFS performance using interrupts, in accordance with an embodiment of the invention. Referring to FIG. 7, there are shown steps 700 to 712. In step 700, the electronic device 100 may monitor a load scale by assessing the MIPS profiling information for one or more processors to accommodate the system load. The monitoring may be via, for example, the DVFS module 400a.

In step 702, an appropriate operating point may be selected by the DVFS module 400a for one or more modules in the electronic device 100 as described with respect to FIG. 6, for example. In step 704, the clock frequencies and/or voltage levels may be adjusted.

In step 706, the electronic 100, which may have been in a sleep mode in, for example, the low load state 310 or the deep sleep state 312, may be awakened via an interrupt. In step 708, the electronic device 100 may determine whether the interrupt is a member of one the specified classes. For example, an interrupt that indicates starting specific applications may be a member of the specified classes of interrupts. If the present interrupt is a member of the specified classes, the next step may be step 710. Otherwise, the next step may be step 702.

In step 710, an operating point associated with the interrupt may be determined. The operating point may be determined from a look-up table, for example, where the look-up table may be the look-up table 108a and/or the look-up table 110a. If the operating point from a look-up table indicates a clock frequency that may be greater than indicated by the DVFS module 400a in step 702, the next step may be step 712. Otherwise, the next step may be step 704.

In step 712, an operating point may be selected based on the specific class of interrupt. For example, one or more modules in the electronic device 100 may be set to operate at a maximum clock frequency if the interrupt is associated with a new task that requires maximum resources.

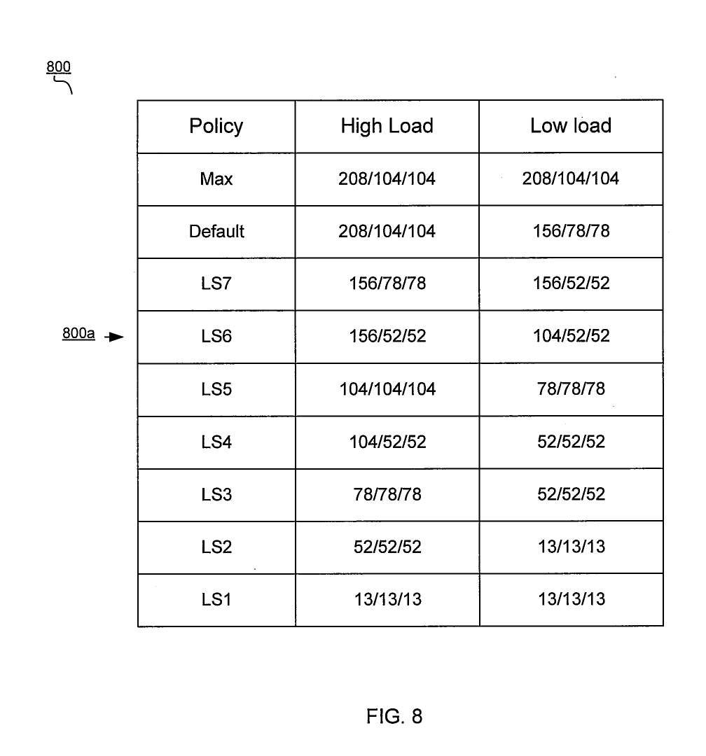

FIG. 8 is a diagram illustrating exemplary policies, in accordance with an embodiment of the invention. Referring to FIG. 8, there is shown a table 800 where various policies may correspond to specific clock frequencies. For convenience, voltage levels are not specified, and the simple state diagram shown with respect to FIG. 3A is used. Accordingly, there may be nine policies, comprising a maximum policy, a default policy, and seven other policies for each of the high load state 304 and the low load state 300. The number of policies may be design dependent.

Each of the nine policies may correspond to an operating point that may comprise various clock frequency values for the high load state 304 and various clock frequency values for the low load state 300. Each of the clock frequency values may correspond to, for example, a module that may be used in the electronic device 100. The modules that may be used in the electronic device 100 may be, for example, an ARM11 processor, an ARM9 processor, and the advanced high-performance bus (AHB). The various policies may be based on, for example, load scaling with respect to the one or more processors and/or modules in the electronic device 100.

Accordingly, for the high load state 304, the policy 800a may result in the ARM11 processor using a 156 MHz clock, and the ARM9 processor and the advanced high-performance bus (AHB) using a 52 MHz clock. In the low load state 300, the policy 800a may result in the ARM11 processor using a 104 MHz clock, and the ARM9 processor and the AHB using a 52 MHz clock.

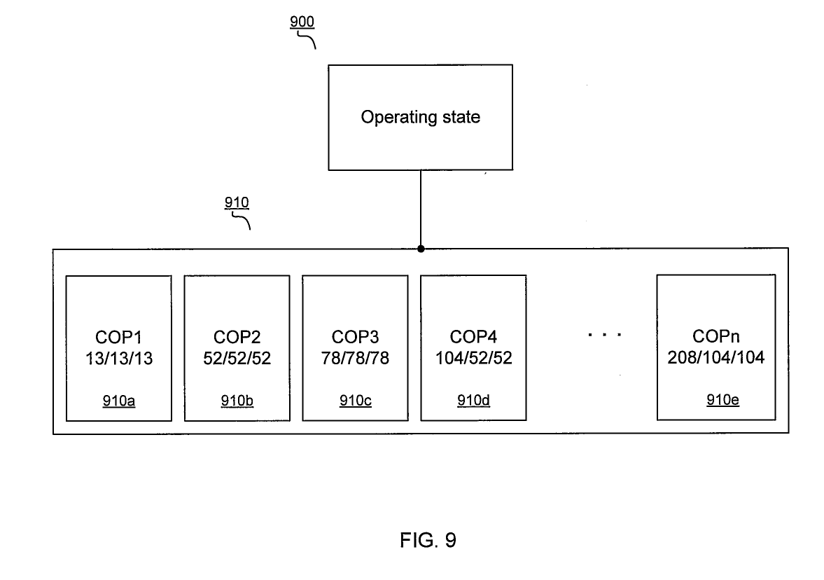

FIG. 9 is a diagram illustrating a policy that maps an operating state to a class of operating points, in accordance with an embodiment of the invention. Referring to FIG. 9, there is shown a state 900 and a set of operating points 910. The state 900 may be, for example, the high load state 304. The set of operating points 910 may comprise the operating points 910a. . . 910e. One or more of the operating points 910a. . . 910e may be mapped to a state. Accordingly, an exemplary mapping may result in the high load state 304 being mapped to the operating points 910c. . . 910e. The mapping algorithm may be design dependent. The mapping algorithm may make mapping relationships static or dynamic based on performance monitoring. For example, if a present load scaling results in processor usage that is at maximum, a different mapping may be made to allow a higher frequency clock to alleviate the processor bottleneck.

In accordance with an exemplary embodiment of the invention, aspects of an exemplary system may comprise the DEM 110 and/or the processor 106 that enable monitoring of resource utilization in the electronic device 100. The DEM 110 and/or the processor 106 may enable determination of a change in the resource utilization that may be greater than a threshold amount. The resource utilization may comprise, for example, a number of instructions executed by a processor, such as the processor 106, within a time period. Accordingly, in instances where the determined change may be greater than the threshold amount, the DEM 110 and/or the processor 106 may enable adjusting of a frequency of at least one clock. The clock frequency adjustment may be determined by, for example, a state of power management, and operating points that may correspond to that state.

In cases where the determined change indicates an increase in resource utilization over time, the frequency of at least one clock may be increased. In instances where the clock may be used by the processor 106, for example, the supply voltage for the processor 106 may also be increased prior to the clock frequency being increased. In cases where the determined change indicates a decrease in resource utilization over time, the frequency of the at least one clock may be decreased. Accordingly, in instances where the clock may be used by the processor 106, for example, the supply voltage for the processor 106 may also be decreased after the clock frequency is decreased.

The processor 106 may also be enabled to handle an interrupt that may indicate, for example, that an application may be about to execute. The DEM module 110 in the electronic device 100 may then, for example, determine an operating point associated with the interrupt. The operating point may be looked up in, for example, the look-up table 108a or 110a. The DEM module 110 may enable selecting either the operating point associated with the interrupt or an operating point determined by a dynamic voltage and clock frequency scaling algorithm. For example, the DEM module 110 may select the larger of the operating point associated with the interrupt or the operating point determined by the DVFS algorithm in the DVFS module 400a.

There may be an operating point associated with the interrupt in instances where the interrupt may be a member of a specified class of interrupts. For example, an interrupt that indicates a start of a task may be member of a class of interrupts. An interrupt that may occur periodically to wake the electronic device 100 may not be a member of a specified class of interrupts that may have an associated operating point. Accordingly, for these instances where there is no operating point associated with an interrupt, the operating point determined by the DVFS module 400a may be used.

Some embodiments of the invention may enable turning off, for example, at least a portion of the DVFS module 400a when entering deep sleep mode in the deep sleep state 302. Similarly, the DVFS module 400a may be enabled when awakened from the deep sleep mode in the deep sleep state 302.

Another embodiment of the invention may provide a machine and/or computer readable storage and/or medium, having stored thereon, a machine code and/or a computer program having at least one code section executable by a machine and/or a computer, thereby causing the machine and/or computer to perform the steps as described herein for dynamic voltage and frequency scaling (DVFS).

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for controlling power consumption, the method comprising:
monitoring resource utilization in an electronic device;
determining a change in said resource utilization that is greater than at least one threshold amount; and
adjusting a frequency of at least one clock in said electronic device and/or voltage for at least one voltage island in said electronic device when said determined change is greater than said threshold amount.

2. The method according to claim 1, wherein monitoring said resource utilization comprises monitoring temperature of at least a portion of at least one chip.

3. The method according to claim 1, wherein monitoring said resource utilization comprises characterizing a speed of at least one chip.

4. The method according to claim 1, wherein said resource utilization comprises a number of instructions executed by a processor within a time period.

5. The method according to claim 1, wherein said resource utilization comprises a rate change in a number of instructions executed by a processor over a plurality of time periods.

6. The method according to claim 1, comprising determining said change in said resource utilization by comparing a number of instructions executed by a processor within a time period to at least one usage threshold and/or comparing a rate change in a number of instructions executed by a processor over a plurality of time periods to at least one rate threshold.

7. The method according to claim 1, comprising increasing said frequency of said at least one clock when said determined change indicates an increase in resource utilization over time.

8. The method according to claim 7, comprising increasing a supply voltage for said at least one voltage island that uses said at least one clock prior to increasing said frequency of said at least one clock.

9. The method according to claim 1, comprising decreasing said frequency of said at least one clock when said determined change indicates a decrease in resource utilization over time.

10. The method according to claim 9, comprising decreasing a supply voltage for said at least one voltage island that uses said at least one clock after decreasing said frequency of said at least one clock.

11. The method according to claim 1, comprising adjusting said frequency of said at least one clock and/or said voltage for said at least one voltage island based on a state of power management.

12. The method according to claim 11, comprising assigning one or more operating points used for said adjusting to each of said state of power management.

13. The method according to claim 11, comprising determining an operating point based on an interrupt received while in said state of power management.

14. The method according to claim 13, comprising selecting a larger of: said operating point associated with said interrupt and an operating point determined by a dynamic voltage and frequency scaling technique, when said interrupt is a member of one of a specified class of interrupts.

15. A system for controlling power consumption, the system comprising:
one or more circuits in an electronic device that enables monitoring of resource utilization in an electronic device;
said one or more circuits enable determination of a change in said resource utilization that is greater than a threshold amount; and
said one or more circuits enable adjusting of a frequency of at least one clock in said electronic device and/or voltage for at least one voltage island in said electronic device when said determined change is greater than said threshold amount.

16. The system according to claim 15, wherein said one or more circuits are operable to monitor temperature of at least a portion of at least one chip in said electronic device for use with monitoring of said resource utilization.

17. The system according to claim 15, wherein said one or more circuits are operable to characterize a speed of at least one chip in said electronic device for use with monitoring of said resource utilization.

18. The system according to claim 15, wherein said resource utilization comprises a number of instructions executed by a processor within a time period.

19. The system according to claim 15, wherein said resource utilization comprises a rate change in a number of instructions executed by a processor over a plurality of time periods.

20. The system according to claim 15, wherein said one or more circuits are operable to determine said change in said resource utilization by comparing a number of instructions executed by a processor within a time period to at least one usage threshold and/or comparing a rate change in a number of instructions executed by a processor over a plurality of time periods to at least one rate threshold.

21. The system according to claim 15, wherein said one or more circuits enable increasing said frequency of said at least one clock when said determined change indicates an increase in resource utilization over time.

22. The system according to claim 21, wherein said one or more circuits enable increasing a supply voltage for said at least one voltage island that uses said at least one clock prior to increasing said frequency of said at least one clock.

23. The system according to claim 15, wherein said one or more circuits enable decreasing said frequency of said at least one clock when said determined change indicates a decrease in resource utilization over time.

24. The system according to claim 23, wherein said one or more circuits enable decreasing a supply voltage for said at least one voltage island that uses said at least one clock after decreasing said frequency of said at least one clock.

25. The system according to claim 15, wherein said one or more circuits enable adjusting said frequency of said at least one clock and/or said voltage for said at least one voltage island based on a state of power management.

26. The system according to claim 25, wherein one or more operating points used for said adjusting are assigned to each of said state of power management.

27. The system according to claim 25, wherein said one or more circuits enable determination of an operating point based on an interrupt received while in said state of power management.

28. The system according to claim 27, wherein said one or more circuits enable selection of a larger of: said operating point associated with said interrupt and an operating point determined by a dynamic voltage and frequency scaling technique, when said interrupt is a member of one of a specified class of interrupts.
